(19) United States
(12) Patent Application Publication
(10) Pub. No.: US 2018/0054301 A1
(43) Pub. Date: Feb. 22, 2018

(54) METHOD AND DEVICE FOR DATA ENCRYPTION

(71) Applicant: KING FAHD UNIVERSITY OF PETROLEUM AND MINERALS, Dhahran (SA)

(72) Inventors: El-Sayed M. EL-ALFY, Dhahran (SA); Ahmad AMRO, Dhahran (SA)

(73) Assignee: KING FAHD UNIVERSITY OF PETROLEUM AND MINERALS, Dhahran (SA)

(21) Appl. No.: 15/241,333

(22) Filed: Aug. 19, 2016

(51) Int. Cl. H04L 9/06; G06F 7/72; G06F 7/58

(52) U.S. Cl. CPC H04L 9/0662; H04L 2209/08; G06F 7/582; G06F 7/72

(57) ABSTRACT

Aspects of the disclosure provide a method for encrypting data. The method includes generating a sequence of states of a pseudo-random number generator (PRNG), generating a key stream including a sequence of key sections based on the sequence of states, and encrypting or decrypting data with the key stream. An initial state of the PRNG is generated based on a seed and a key, and each of other states in the sequence of states of the PRNG is generated based on a previous state of the PRNG and the key. The method eliminates the vulnerability to known-plaintext attack, and improves the security of communications between computer systems. Also, the method showed a performance improvement when compared to the Advanced Encryption Standard (AES) in cipher block chaining (CBC) mode. Moreover, the size of the encrypted data is almost the same as that of the original data.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Cryptography aims to make the data incomprehensible without the knowledge of a secret key (whether a private key in asymmetric cryptography or a shared key in symmetric cryptography). In contrast, cryptanalysis aims to find and exploit security flaws in a certain cryptographic system. The security level of a cryptographic system depends on the complexity involved in cryptanalysis to break this system. Cryptanalysis attacks can be categorized into four main types based on what the attacker can access: ciphertext only, known plaintext, chosen plaintext, and chosen ciphertext.

Generally, the perfect secrecy of an encryption algorithm requires the use of truly random numbers. However, the generation of unpredictable random numbers using a true random number generator (TRNG) is inherently slow and requires a piece of hardware that depends on a physical process, such as thermal noise, to generate the random numbers. A reasonable alternative, yet is not unpredictable, is to use a pseudorandom number generator (PRNG) to generate a random sequence calculated from a deterministic mathematical function with an initial seed value. A common requirement of PRNGs is that they possess good statistical properties, meaning their output approximates a sequence of true random numbers. One example of the PRNG is implemented in MATLAB software that produces uniformly distributed pseudo-random numbers, also called scalars, whose values are calculated from a uniform distribution of some period or interval.

Some tests are typically carried out to verify the randomness of the output of a cryptosystem, such as plaintext sensitivity test and key sensitivity test. Plaintext sensitivity is measured by the amount of changed bits in the ciphertext when encrypting the same plaintext only with a small difference (e.g. one bit flipped). Key sensitivity is measured by the amount of changed bits in the ciphertext when encrypting the same plaintext with a small change to the key such as flipping a single bit.

Many applications employ PRNGs in their encryption algorithms. For example, a block cipher designed for wireless sensor networks was introduced in the work of K. Biswas, V. Muthukkumarasamy, and K. Singh, “An encryption scheme using chaotic map and genetic operations for wireless sensor networks,” Sensors Journal, IEEE, vol. 15, no. 5, pp. 2801-2809, 2015, which is incorporated by reference herein by its entirety. Their proposed cipher applies PRNGs based on chaotic maps and is composed of three phases: key establishment, pseudo-random bit sequence generation, and encryption. The key-generation phase depends on elliptic curves over prime fields to generate large key pools. Subsequently, keys are randomly selected from these pools and sent to the appropriate sensors. The pseudo-random bit sequence generation is based on chaotic functions to provide secure randomness and large period. The chaotic function is seeded with values pre-distributed in the key generation phase. The last phase is the encryption phase, in which the pseudo-random bit sequence generated in the previous phase is used to encrypt the data using three different operations: XOR, mutation and crossover.

Another method employing PRNGs is described for selective image encryption in the work of A. M. Ayoup, A. H. Hussein, and M. A. Attia, “Efficient selective image encryption,” Multimedia Tools and Applications, pp. 1-16, 2015, which is incorporated by reference herein by its entirety. The encryption process begins with selecting sensitive areas chosen from the blocks with the highest entropy values among the plain image blocks. Next, a pseudo-random sequence is generated from a linear feedback shift register (LFSR). The pseudo-random sequence is distributed over a matrix of a size matching the image size. The image matrix is initially encrypted with the matrix filled with the pseudo-random sequence. After that, the output matrix is transformed using what is called Arnold transformation. This transformation randomizes the organization of the image matrix to provide diffusion. Finally, the sensitive image areas previously selected are encrypted using the advanced encryption standard (AES).

An example of cryptanalysis of ergodic chaotic cryptosystem is described in the work of G. Alvarez, F. Montoya, M. Romera, and G. Pastor, “Cryptanalysis of an ergodic chaotic cipher,” Physics Letters A, vol. 311, no. 2, pp. 172-179, 2003, which is incorporated by reference herein by its entirety. They performed an intensive study of the cipher algorithm using four attacks. One-time pad attack showed that the algorithm reuses some of its keys which would destroy the one-time condition of a one-time pad, thus, makes it breakable. For the entropy attack, which is similar to statistical attacks, the authors found that the entropy of the encrypted text is not as close to the ideal entropy as it should, which allows some predictability. The other two attacks are key recovery of a weakened version of the cipher via initial value estimation and via parameters estimations, respectively. It has been shown that if a part of the key is known, the entire key can be recovered. The two key recovery attacks are not general. They work only if some parameters are not taken care of, which is not the case in most industrial applications.

### SUMMARY

Aspects of the disclosure provide a method for encrypting and decrypting data. The method includes generating a sequence of states of a PRNG, generating a key stream including a sequence of key sections based on the sequence of the states, and encrypting or decrypting the data with the key stream to generate encrypted data or decrypted data respectively. An initial state of the PRNG is generated based on a seed and a key, and each of the other states in the sequence of states of the PRNG is generated based on a previous state of the PRNG and the key. Each key section is generated by the PRNG based on one of the sequence of the states of the PRNG.

An example of the method includes performing a modulo-m addition or multiplication of the seed and the key to generate the initial state of the PRNG, and performing a modulo-m addition or multiplication of a previous state of PRNG and the key to generate one of the other states in the sequence of states of the PRNG.

In one example, when the input data is data to be encrypted, the method further includes generating the seed as a random number for encrypting the data, and incorporating the seed with the encrypted data. The seed is encrypted before being incorporated with the encrypted data. In another example, when the input data is the encrypted data to be decrypted, the method further includes extracting the seed from the encrypted data incorporating the seed. The method further includes performing an encryption operation with a block of the input data as a first input and a key of the key stream as a second input to generate encrypted data or decrypted data respectively. In one example, the encryption operation is an XOR operation (due to its simplicity).

Aspects of the disclosure provide an electronic device for encrypting and decrypting data. The electronic device includes processing circuitry configured to generate a sequence of states of a pseudo-random number generator (PRNG), generate a key stream including a sequence of key sections based on the sequence of the states, and encrypt or decrypt the data with the key stream to generate encrypted data or decrypted data respectively. An initial state of the PRNG is generated based on a seed and a key, and each of the other states in the sequence of states of the PRNG is generated based on a previous state of the PRNG and the key. Each key section is generated by the PRNG based on one of the sequence of the states of the PRNG.

Aspects of the disclosure provide a non-transitory computer readable storage medium having computer readable instructions stored thereon. The instructions, when executed by processing circuitry, cause the processing circuitry to perform a method. The method includes generating a sequence of states of a PRNG, generating a key stream including a sequence of key sections based on the sequence of the states, and encrypting or decrypting the data with the key stream to generate encrypted data or decrypted data respectively. An initial state of the PRNG is generated based on a seed and a key, and each of the other states in the sequence of states of the PRNG is generated based on a previous state of the PRNG and the key. Each key section is generated by the PRNG based on one of the sequence of the states of the PRNG.

The encryption scheme described herein eliminates the vulnerability to known-plaintext attack which some PRNG-based encryption methods suffer from. In addition, the size of the ciphertext generated by the encryption scheme is almost the same as that of the input plaintext.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary encryption block diagram of a PRNG-based text encryption;

FIG. 2 shows an example of calculation of values of a sequence of random numbers based on a known plaintext/ciphertext pair;

FIG. 3 shows an example of calculation of a plaintext using a ciphertext and the previously acquired values of the sequence of random numbers;

FIG. 4 shows an encryption block diagram illustrating an example process of a data encryption scheme;

FIG. 5 shows a table including results of six tests performed to reflect different aspects of plaintext and key sensitivity of the data encryption scheme;

FIG. 6 shows a table including results of two tests performed to reflect average plaintext and key sensitivity of the data encryption scheme over multiple repetitions according to one example;

FIG. 7 shows a table including results of three tests performed to reflect performance of the implemented data encryption scheme according to one example;

FIG. 8 shows a block diagram of an electronic device according to an example of the disclosure; and

FIG. 9 shows a table illustrating experimental results of benchmarking the data encryption scheme against AES-128 in cipher block chaining (CBC) mode.

### DETAILED DESCRIPTION

A data encryption scheme for PRNG-based symmetric stream cypher is described in this detailed description according to the disclosure. A text encryption approach is described in the work of M. Mishra and V. Mankar, “Text encryption algorithms based on pseudo random number generator,” International Journal of Computer Applications, vol. 111, no. 2, pp. 1-6, 2015, the entire contents of which are herein incorporated by reference. The cryptanalysis of the text encryption approach is first described below before the description of the data encryption scheme.

I. Cryptanalysis of the Text Encryption Approach

The cryptanalysis is performed on two PRNG-based text encryption algorithms described by M. Mishra and V. Mankar. The two algorithms are named as RNG method and modified RNG method according to the types of PRNGs used in the respective algorithm.

A. RNG Method

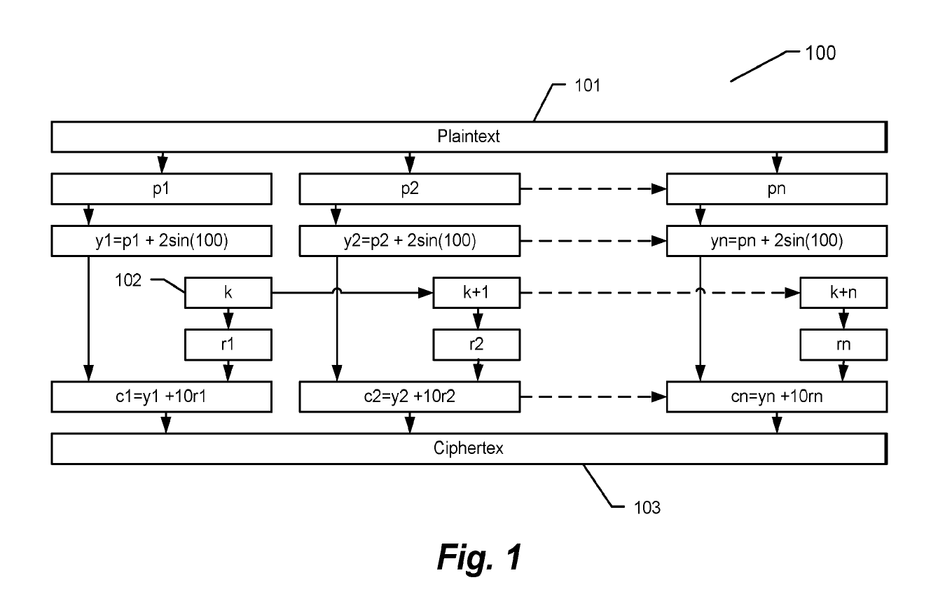

The RNG method was developed based on a uniformly distributed MATLAB RNG. However, any other uniformly distributed RNG can be used for the RNG method instead of the MATAB RNG. FIG. 1 shows an encryption block diagram 100 of the RNG method. As shown, the RNG method can include the following three steps:

(1) The plaintext 101 and key 102 are received as inputs. The plaintext 101 is subsequently transformed into a sequence of ASCII values, p1 to pn, where n represents the number of text characters in the plain text 101. The i-th text character value of the sequence of values, p1 to pn, is expressed as pi. Based on the value of the key 102, k, a sequence of states of the MATLAB RNG is generated in a way that each state in the sequence is incremented based on a previous state, and the value of the key 102 is used as an initial value. As a result, the sequence of the states are, k, k+1, k+n, and ki represents the i-th state in the sequence of the states.

(2) The text character value pi of the i-th text character of the plaintext 101 is transformed into a value ci using the following equations:

yi=pi+2 sin(100) (1)

ci=yi+10ri (2)

where ri is a random number generated by the i-th state, ki, of the MATLAB RNG.

(3) The integer value of ci is then transformed into an i-th character in a ciphertext 103 for the i-th text character of the plaintext 100.

Security Weakness of the RNG Method

The i-th character in the ciphertext 103 is calculated using two values: the i-th character value pi and the i-th random value ri generated from the i-th state. The expressions (1) and (2) can be combined to represent the encryption by a single expression:

ci=pi+2 sin(100)+10ri (3)

Reversing this expression (3) results in:

pi=ci−2 sin(100)−10ri (4)

In the RNG method, the sequence of values of ri are fixed for each value of k used to generate the sequence of values of ri. This also indicates that all the trajectories from values of k and consecutive k's (k+1, k+2, etc.) result the same stream values of r (r1, r2, etc). Accordingly, if the stream values of ri is known and the key does not change, a plaintext can be calculated according to expression (4).

Ciphertext-only attack is possible only if the key domain is small. Therefore, the key size should be large enough, for example, to be at least equivalent to the standard AES-256 key size of 256 bits, to avoid Brute-Force attacks.

Both chosen plaintext and ciphertext attacks would not result in finding the key, since the values of k, k+1, . . . , etc., cannot be calculated from the values of r1, r2, etc. Known-plaintext attack, on the other hand, can lead to breaking the encryption. For example, if an attacker obtains a plaintext/ciphertext pair, he can easily calculate the stream values of ri according to expression (5):

ri=(ci−2 sin(100)−pi)/10 (5)

The length of the stream values of ri depends on the length of the obtained plaintext/ciphertext pair. If the attacker knew that another ciphertext was encrypted with the same key, he can calculate part of the plaintext equal to the length of the acquired stream values of ri. Although the attacker cannot easily calculate the key 102 that results in these values of ri, it gives the attacker some information.

A Known-plaintext Attack Example of the PRNG Method

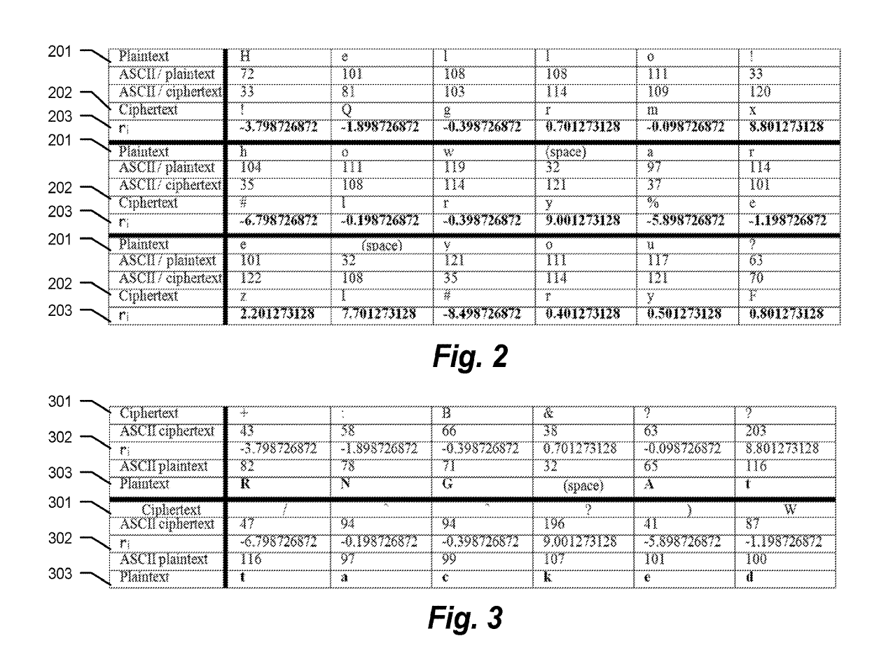

FIG. 2 shows an example of calculation of values of a sequence of random numbers ri based on a known plaintext/ciphertext pair. In the example, an attacker acquired the following plaintext “Hello!how are you?” included in rows 201 and the corresponding ciphertext “!Qgrmx#lry%ezl#ryF” included in rows 202. The length of both the plaintext and ciphertext is 18. Using the above expression (5), the attacker can calculate 18 values of the sequence of random numbers ri (included in rows 203) related to the key that was used to acquire the above known plaintext/ciphertext pair.

FIG. 3 shows an example of calculation of a plaintext using a ciphertext and the previously acquired values of the sequence of random numbers ri. This example assumes the attacker acquired the ciphertext included in rows 301 in FIG. 3 and he knew that the key that was used to encrypt this ciphertext is the same as the previous key. The previously acquired values of the random numbers ri are included in rows 302. If the length of the ciphertext is less than 18, the attacker can recover the entire corresponding plaintext using expression (4). FIG. 3 shows the calculation of the plaintext in rows 303 corresponding to the captured ciphertext in rows 301. Consequently, the attacker has recovered the plaintext “RNG Attacked”.

In various examples, the plaintext/ciphertext pair can be obtained in various ways. For example, the attacker can send an email message to some people and ask them to forward it, and use a packet sniffer to obtain the corresponding cipher text. Also the complexity of this attack is low. A special case that makes the known-plaintext attack fail to recover the entire plaintext would be if the attacker obtained a plaintext/ciphertext pair shorter than the ciphertext he wishes to decrypt. Then, the length of the stream values of ri would not be large enough to calculate the whole plaintext of a larger ciphertext.

For the PRNG method, when the key is reused to encrypt smaller data after encryption of large data, the stream values of ri would be large enough to expose the entire short text. From a practical point of view, this method cannot be used for encrypting large amount of data, since at some point the key domain will be entirely used and this would increase the probability of exposing the ciphertext using a previously used key.

B. Modified RNG Method

The modified RNG method applies the same generator as in the RNG method. A modification is made to enhance the plaintext sensitivity which the RNG method suffers from. But, in a similar way the modified RNG method is still vulnerable to known-plaintext attack. The encryption process of the modified RNG method involves a series of matrix shifting and resizing. Each plaintext character is being changed twice. The first time the plaintext value pi is being XOR-ed with the random numbers ri generated from the RNG states ki, as shown in expression (6):

pi′=pi⊕ri (6)

where p′ is an intermediate value. Next, the random number, ri, is added to the modified plaintext as pi′, as shown in expression (7):

ci=pi′+(ri mod 128) (7)

After the above calculation is done for all the plaintext characters, another series of reversible matrix shifting and resizing is performed. All the matrix shifting and resizing are reversible. Accordingly, combining expressions (6) and (7) results in:

ci=(pi⊕ri)+(ri mod 128) (8)

Since the values of ri are always the same for the same secret key k, this would make the method vulnerable to known-plaintext attack. Having enough pairs of plaintext/ciphertext of length L, the attacker will be able to calculate the stream of values of ri of length L. Furthermore, any plaintext with length less than or equal to L encrypted with the same key can be fully recovered from the ciphertext using the pre-calculated stream values of ri.

II. Data Encryption Scheme

According to an aspect of the disclosure, the data encryption scheme described herein eliminates the vulnerability to known-plaintext attack that the above described RNG method and modified RNG method suffer from, thus improving the security of communications between computer systems. Moreover, the size of the ciphertext is almost the same as that of the plaintext in the data encryption scheme.

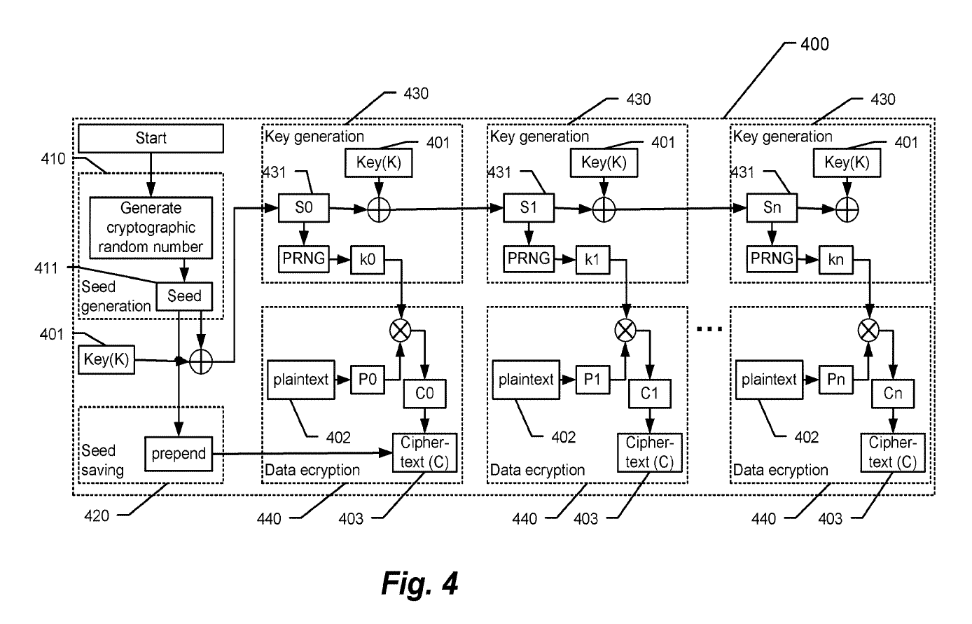

FIG. 4 shows an encryption block diagram illustrating an example process 400 of the data encryption scheme. As shown, the process 400 takes as input a key K 401 and a plaintext P 402, and generates an encrypted ciphertext C 403 as output. Here, plaintext is used to refer to any kind of plain data and ciphertext is used to refer to any kind of encrypted data to maintain the traditional terminology in the art. In an example, the key 401 is a key shared between two parties during a communication session. The process 400 includes four stages in one example.

Stage one 410: Seed Generation. A random number is generated which is referred to as a Seed 411. In one example, the Seed 411 is generated from a cryptographically secure PRNG. Each encryption process generates a random Seed that is subsequently used to produce different stream of random numbers for the respective encryption process. As a result, even the same plaintext encrypted twice with the same key K 401 would have an entirely different ciphertext each time.

Stage two 420: Seed Saving. The value of the Seed 411 can be used for decrypting data encrypted by the process 400. Hence, in an example, it is prepended to the ciphertext. For file encryption, in another example, it is can be the first value written to the file in the encryption process. Also, in this example, it will be the first value read from the file in the corresponding decryption process. In an example of a stream cypher, it is sent before sending the ciphertext and before the decryption process begins. This value of the Seed 411 does not have to be secret and can be saved or sent in plaintext.

Stage three 430: Key Stream Generation. The numeric value of the key K 401 and the Seed 411 are used for calculation of a sequence of intermediate states Si, i=0, 1, . . . , n, of a PRNG 431. The calculations of each state Si can be performed in modulo m. To do so, the first step is to calculate an initial state S0 for the PRNG 431. This is accomplished by adding the value of the Seed 411 to the numeric value of the key K 401 in an example. Addition can be performed in mod m (a large prime integer) shown as follows:

S0=numeric(K)+Seed(mod m) (9)

In one example, other states Si are calculated by adding the previous state Si−1 to the numeric value of K 401 as follows:

Si=numeric(K)+Si⁻¹(mod m) (10)

It is noted that multiplication can be used instead of addition in expressions (9) and (10) in various examples.

Subsequently, in stage three, a key stream is generated based on the above generated states Si. In one example, the key stream includes a sequence of key sections ki, i=0, 1, n, and each state Si is used to generate a key section ki from the PRNG 431:

ki=PRNG(Si) (11)

where, the random value ki is generated from the PRNG 431 using Si as the PRNG state.

Stage four 440: Text Encryption. The key stream generated at stage 430 can be used to encrypt the plaintext 402. In one example, an XOR operation is performed on a key stream bit and a plaintext bit to generate a ciphertext bit. The generated ciphertext bits form the ciphertext C. In one example, the plaintext 402 includes a sequence of plaintext section Pi, i=0, 1, . . . , n, and each plaintext section Pi corresponds to a key section ki generated from the PRNG with the state Si. Accordingly, a ciphertext section Ci, i=0, 1, . . . , n, can be calculated by XOR-ing each plaintext section Pi with each corresponding key section ki:

Ci=ki⊕Pi (12)

The sequence of calculated cipher text section Ci forms the ciphertext 403.

A decryption process corresponding to the encryption process 400 is similar to the encryption process 400. The only difference between the decryption process and the encryption process 400 is that at the beginning of a decryption process, stage one 410 is skipped, since there is no need to generate a new Seed 411, and a new Seed will generate a totally different key stream which will lead to a false decryption of the ciphertext. Instead, as the value of the seed 411 is prepended to the ciphertext in stage two 420 of the encryption process, the first step in the decryption process is Seed reading, then followed by stage three 430 and stage four 440 that are exactly the same as stage three 430 and stage four 440 in the encryption process 400.

III. Security Analysis of the Data Encryption Scheme

Four cryptanalysis attacks in addition to plaintext and key sensitivity are analyzed below with respect to the process 400 of the data encryption scheme in FIG. 4.

Ciphertext-Only Attack: brute-force attack would be possible if the key domain of the key 401 is small. For this reason, in various examples, the size of the key 401 is unlimited. Accordingly, since the key 401 is used to calculate each PRNG state Si in mod m, the value of m is selected to be large enough to process large keys.

Known-Plaintext Attack: if an adversary has access to partial plaintext/ciphertext pair, he can only calculate the value of the key stream bits that are used to encrypt that specific plaintext to that specific ciphertext. No knowledge to calculate the following key stream bits since the value of the key K 401 is required to calculate the next PRNG state. Also if the same key was used to encrypt two plaintext values, the Seed value would be different, resulting in a different key stream. So, the attack that succeeded on the RNG method would not succeed when applying this method.

Chosen-Plaintext Attack: If the period of the PRNG responsible for generating the value of the Seed at stage 410 is not large enough resulting in repeating values of the Seed 411 in a short time the following attack is possible. For example, if an attacker has access to a device with the encryption algorithm having a fixed key 401 embedded inside it, the attacker can encrypt some long plaintext multiple times until the same Seed 411 repeats while recording the ciphertext at each time. Thus, it is possible to calculate all the possible key streams that would be generated from that fixed key 401. The attacker can then maintain a database containing all possible values of the Seed 411 and the corresponding key streams that are generated from that Seed 411 and the fixed key 401. Later, any new transaction generated from that device can be decrypted by the attacker. To fail this attack, in various examples, the possible values of the Seed 411 are set large enough to make sustaining such database infeasible. An alternative solution, in one example, is to encrypt the Seed 411 such that the attacker does not know when a same Seed 411 is repeated.

Chosen-Ciphertext Attack: If an attacker has access to a device with the decryption algorithm having the key 401 embedded inside of it, the attacker may try to decrypt some chosen ciphertext and collect the corresponding plaintext. But this attack would not give any information about the key since the value of the key 401 is not presented directly into the decryption process. The key is used to control the state Si of the PRNG 431 and calculate the key streams. The attacker can calculate the value of the key stream, but this information will not help in knowing the key 401 since figuring out the state of the PRNG from the random numbers is supposed to be computationally infeasible.

Plaintext and Key sensitivities: The implementation of the random Seed 411 at the beginning of each encryption process 400 would reflect randomness over the ciphertext. Even encrypting the same plaintext with the same key 401 would generate entirely different ciphertext, since the Seed 411 is chosen at random and the period of the PRNG generating the Seed is supposed to be securely large.

IV. Evaluation of the Data Encryption Scheme

The data encryption scheme is implemented using MATLAB for both string and file encryption in an example. Also sensitivity tests are implemented for bit-level plaintext and key sensitivity.

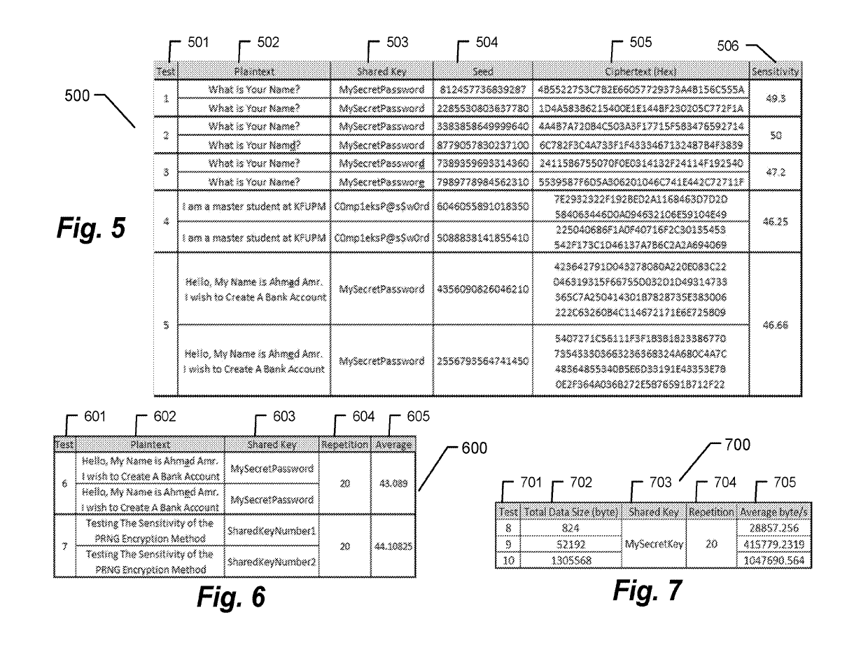

FIG. 5 shows a table 500 including results of six tests performed to reflect different aspects of plaintext and key sensitivity of the data encryption scheme described herein. The table includes six columns 501-506. Column 501 indicates numbering of tests 1-5. Column 502 includes plaintext in each row used for the tests. Columns 503 and 504 show shared keys and Seeds, respectively, for encryption of each plain text in column 502. Column 505 includes ciphertext generated from each plaintext in column 502. Column 506 shows values of measured sensitivity metrics corresponding to each test.

Test 1 was performed to show the effect on the ciphertext when encrypting the same plaintext twice using the same secret key. The sensitivity scored was 49.3%. Test 2 was performed to show the effect on the ciphertext when encrypting two plaintexts with a small difference (e and d differ in one bit) using the same secret key. The sensitivity scored was 50%. Test 3 was performed to show the effect on the ciphertext when encrypting the same plaintext twice using two secret keys with a small difference (e and d differ in one bit). The sensitivity scored was 47.2%. Test 4 was performed to show the effect on the ciphertext when encrypting the same plaintext twice using the same secret key but more complex than in tests 1-3. The sensitivity scored was 46.25%. Test 5 was performed to show the effect on the ciphertext when encrypting the same plaintext twice with a small difference (a and e differ in one bit) using the same secret key. The sensitivity scored was 46.66%.

FIG. 6 shows a table 600 including results of two tests performed to reflect the average plaintext and key sensitivity of the data encryption scheme over multiple repetitions. The table 600 includes five columns 601-605. Column 601 shows numbering of the tests 6-7. Column 602 shows in each row a plaintext used in the tests 6-7. Column 603 shows shared keys used in the tests 6-7. Column 604 shows repetition times in each of tests 6-7. Column 605 shows average values of plaintext and key sensitivity metrics.

Test 6 was performed to calculate the average plaintext sensitivity when encrypting two plaintexts with small difference (a and e differ in one bit) using the same secret key and the process is repeated 20 times. The average plaintext sensitivity recorded was 43.089%. Test 7 was performed to calculate the average key sensitivity when encrypting the same plaintext twice using two secret keys with a small difference (1 and 2 differ in one bit) and the process is repeated 20 times. The average key sensitivity recorded was 44.10825%.

FIG. 7 shows a table 700 including results of three tests performed to reflect performance of the implemented data encryption scheme. The performance is defined as an amount of bytes processed by the implementations during a period of time. The table 700 includes five columns 701-705. Column 701 indicates numbering of the tests 8-10. Column 702 shows a total data size (in byte) of plaintexts processed in each test. Column 703 shows a share key used in the three tests 8-10. Column 704 shows the repetition times in each test. Column 705 shows of average performance (in byte/s) of each test 8-10.

At each test, certain plaintext with specific size is specified. The plaintext is encrypted then decrypted back and the processing time is recorded. Then performance corresponding to the process is calculated. The process is repeated twenty times and average performance is calculated subsequently. For example, in test 8, the data size was 824 bytes (412 bytes plaintext and the same for ciphertext). When repeating the process 20 times, the average rate of encrypting then decrypting data was 28,857.256 bytes/second. Going from Test 8 to Test 10, the size of data processed was increased as shown in column 702. It is clear that the performance increases when the size of the data increases as shown in column 705.

V. Electronic Devices Implementing the Data Encryption Scheme

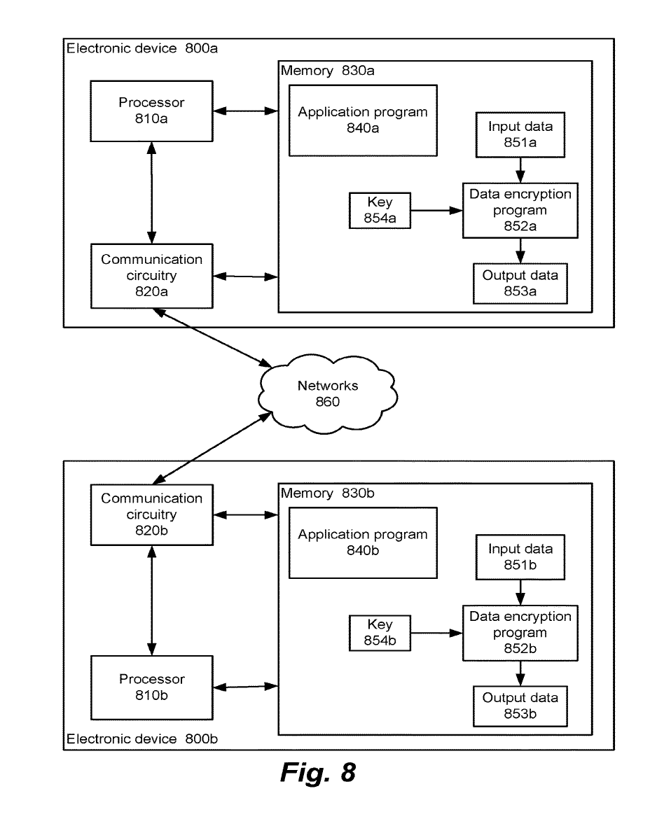

FIG. 8 shows a block diagram of two electronic devices 800a and 800b according to an example of the disclosure. The two electronic devices 800a and 800b communicate via communication networks 860. The electronic device 800a includes hardware components, such as a processor 810a, communication circuitry 820a, a memory 830a, as well as software components, such as various code instructions stored in the memory 830a. The hardware components are coupled together as shown in FIG. 1, and operate according to the software components to perform various tasks.

The electronic device 800a can be any suitable device, such as a desktop computer, a laptop computer, a mobile phone, a tablet, a multimedia player, a pocket calculator, a personal digital assistant (PDA), a smart watch, a smart camera and the like. The electronic device 800a can include other suitable components (not shown), such as a display, a touchscreen, a microphone, and the like. In an example, the electronic device 800a includes a single integrated circuit (IC) chip that integrates various circuits, such as the processor 810a, the communication circuitry 820a, the memory 830a, and the like on the single IC chip. In another example, the electronic device 800a includes multiple IC chips, such as a processor chip, a communication chip, a memory chip, and the like.

The processor 810a includes one or more processing units to execute various code instructions to perform various tasks. In an example, the processor 810a is a multi-core processor, such as a dual-core processor, a quad-core processor, and the like. In addition, the processor 810a can have any suitable architecture, such as an ×86 architecture, a reduced instruction set computing (RISC) architecture, a complex instruction set computing (CISC) architecture, and the like. In an example, the electronic device 800a is a mobile device having an advanced RISC machine (ARM) type processor. The code instructions can be low level codes, such as machine native codes, that can be directly executed by the processor 810a or can be high level codes, such as in Java language, in C language and the like, that can be translated to the machine codes and then executed.

The memory 830a includes one or more storage media that provide memory spaces for various storage needs. In an example, the memory 830a stores code instructions to be executed by the processor 810a and stores data to be processed by the processor 810a. In another example, the memory 830a includes memory spaces allocated for system storage, and memory spaces allocated for user storage. The storage media include, but are not limited to, hard disk drive, optical disc, solid state drive, read-only memory (ROM), dynamic random access memory (DRAM), static random access memory (SRAM), flash memory, and the like.

The memory 840a stores an application program 840a. In one example, the application program 840a is a file encryption program configured to encrypt or decrypt a file. In another example, the application program 840a is a communication program, such as an instant message program, a Telnet program, and the like, which transmits or receives data, such as text/voice messages, via the communication circuitry 820a.

In one example, the memory 830a further stores a data encryption program 852a that implements the data encryption schemes described herein. In another example, the data encryption program 852a is included in the application program 840a. The memory 830a further stores input data 851a that is to be processed by the encryption program 852a to produce output data 853a stored in the memory 840a. In addition, the memory 830a stores a key 854a that is used by the data encryption program 852a to encrypt or decrypt data. In various examples, the key 854a can be received from outside the electronic device 800a via the communication circuitry 820a, or retrieved from a storage medium, such as a portable flash memory device.

The communication circuitry 820a is configured to provide communication channels for the components in the mobile device 800a to communicate with other computers or devices via communication networks 860. The communication networks 860 can include WLANs, wired-LANs, wireless cellular networks, Internet, wide-area networks, and the like. Accordingly, the communication circuitry 820a can operate with various communication protocols, such as WiFi, Bluetooth, Internet protocols, wireless cellular network protocols (e.g. general packet radio service (GPRS), wideband code division multiple access (WCDMA), Long-Term Evolution (LTE)), any other communication protocols, or any combination thereof.

In operation, the data encryption program 852a is executed by the processor 810a to perform data encryption or decryption operations. For example, when the data encryption program 852a is executed, the processor 810a performs the process 400 in FIG. 4.

In an example, when the application program 840 is executed, the processor 810 performs a file encryption or decryption process. The data encryption program 852 is executed to generate an encrypted file, or decrypt an encrypted file to generate an unencrypted file.

The electronic device 800b has components similar to that of the electronic device 800a in one example. For example, the electronic device 800b can include a processor 810b, communication circuitry 820b, a memory 830b, and other components (e.g., a display, a touch screen, a microphone, and the like) that have structures and functions similar to that of the corresponding components in the electronic device 800a. Descriptions of the electronic device 800b and its components are omitted for brevity.

Similarly, in one example, the memory 830b stores an application program 840b and a data encryption program 852b that are similar to the application program 840a and the data encryption program 852b in the memory 830a in the electronic device 800a. When executed by the processor 810b, the application program 840b and the encryption program 852b causes the processor 810b to perform operations similar to that performed by the processor 810a, such as generating and processing the input data 851b and subsequently generating the output data 853b.

In one example, at the side of the electronic device 800a, when the application program 840a is executed, the processor 810a receives inputs from a user and generates text/voice messages that are stored as the input data 851a. The processor 810a then executes the data encryption program 852a encrypting the input data 851a to generate the output data 853a based on the key 854a, and subsequently transmits the output data 853a outside of the electronic device 800a via the communication device 820a.

At the side of the electronic device 800b, when the application program 840b is executed, the processor 810b receives encrypted data from outside of the electronic device 800a through the networks 860. The processor 810b then executes the data encryption program 852b to decrypt the encrypted data (that is taken as the input data 851b) to generate decrypted data (the output data 853b). The key 845b, which is the same as the key 845a, can be used during the decryption operation. The decrypted data (output data 853b), such as a text/voice message, is subsequently presented to a user of the electronic device 800b.

VI. Deployment Examples and Performance Improvement Against Standard Encryption Techniques

In some applications, the data encryption scheme is targeting the privacy protection of streamed data generated by devices of low-computational capabilities and/or transferred over low-band networks. Without restriction of the application scope of the data encryption scheme, three deployment examples are described below.

The first deployment example is short text and voice message encryption/decryption in instant messaging applications in smartphones. An example of similar application is TextSecure which has started as an application for sending and receiving encrypted SMS messages. In November, 2014, Whatsapp has incorporated Textsecure to provide end-to-end security and protection against eavesdropping. Signal 2.0 was released in March 2015 for iOS which integrates TextSecure with RedPhone. The encryption/decryption in TextSecure depends on Advanced Encryption Standard (AES) in cipher block chaining (CBC) mode with padding.

The second deployment example is application in some wireless technologies. For example, Zigbee is used for wireless communication in Internet-of-Things (IoT) or sensor networks where short data is to be transmitted securely and quickly over low-band channels. Another example is Bluetooth for exchanging data over short distances. Zigbee supports AES-128 encryption standard where the frame size is 127+6=133 Bytes maximum.

The third deployment example is application in byte-stream applications such as Telnet for exchanging data. In some examples, telnet transmits data unencrypted over the channel.

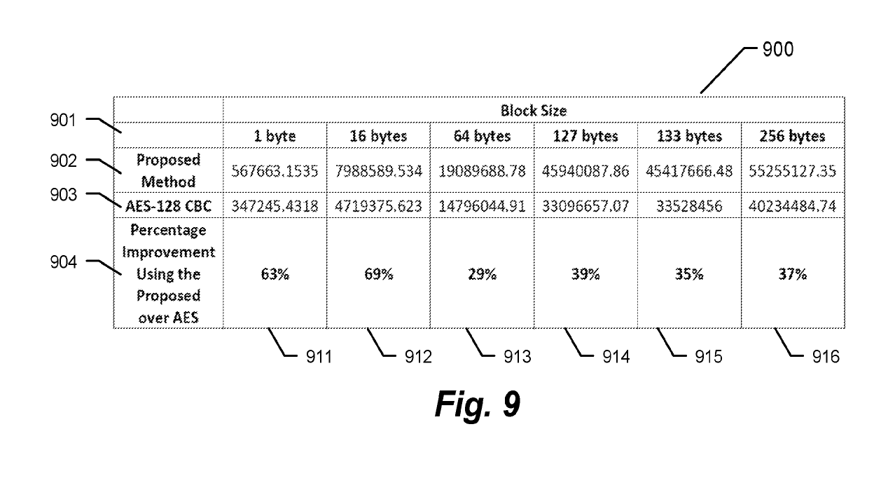

In one example, in order to benchmark the data encryption scheme against AES-128 in CBC mode which is used in the above mentioned applications, an experiment is performed in which the throughput for each approach (number of bytes processed in one second) is measured. For AES, implementation in the open source Crypto++ library is used. For both AES and the data encryption scheme, a stream of blocks (each block represents a message of certain size) of 0.5 MB (megabytes) is transmitted, and seven different block sizes are tested. The experimental results are shown in a table 900 in FIG. 9.

In the table 900, the row 901 shows different block sizes of transmitted blocks in columns 911 to 916. The row 902 shows measured throughputs of the data encryption scheme corresponding to different block sizes. The row 903 shows measured throughputs of the AES-128 in CBC mode corresponding to different block sizes. The row 904 shows percentage improvement of the data encryption scheme over the AES corresponding to different block sizes. As shown, compared with the AES-128 in CBC mode, improvements of 29% to 69% of the throughput are acquired when the data encryption scheme is employed.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method for encrypting and decrypting data, comprising:
generating a sequence of states of a pseudo-random number generator (PRNG), wherein an initial state of the PRNG is generated based on a seed and a key, and each of the other states in the sequence of states of the PRNG is generated based on a previous state of the PRNG and the key;
generating, via processing circuitry, a key stream including a sequence of key sections, wherein each key section is generated by the PRNG based on one of the sequences of the states of the PRNG; and
encrypting or decrypting the data with the key stream to generate encrypted data or decrypted data respectively.

2. The method of claim 1, wherein generating the sequence of states of the PRNG includes,
performing a modulo-m addition or multiplication of the seed and the key to generate the initial state of the PRNG; and
performing a modulo-m addition or multiplication of a previous state of PRNG and the key to generate one of the other states in the sequence of states of the PRNG.

3. The method of claim 1, wherein when the data is data to be encrypted, the method further comprises:
generating the seed as a random number for encrypting the data; and
incorporating the seed with the encrypted data.

4. The method of claim 3, further comprising:
encrypting the seed before incorporating the seed with the encrypted data.

5. The method of claim 1, wherein when the data is encrypted data to be decrypted, the method further comprises:
extracting the seed from the encrypted data incorporating the seed.

6. The method of claim 1, wherein encrypting or decrypting the data with the key stream includes performing an encryption operation with a data bit of the data as a first input and a key stream bit of the key stream as a second input to generate encrypted data or decrypted data respectively.

7. The method of claim 6, wherein the encryption operation is an XOR operation.

8. An electronic device for encrypting and decrypting data, comprising processing circuitry configured to,
generate a sequence of states of a pseudo-random number generator (PRNG), wherein an initial state of the PRNG is generated based on a seed and a key, and each of the other states in the sequence of states of the PRNG is generated based on a previous state of the PRNG and the key,
generate a key stream including a sequence of key sections, wherein each key section is generated by the PRNG based on one of the sequence of the states of the PRNG, and
encrypt or decrypt the data with the key stream to generate encrypted data or decrypted data respectively.

9. The electronic device of claim 8, wherein the processing circuitry is further configured to
perform a modulo-m addition or multiplication of the seed and the key to generate the initial state of the PRNG, and
perform a modulo-m addition or multiplication of a previous state of PRNG and the key to generate one of the other states in the sequence of states of the PRNG.

10. The electronic device of claim 8, wherein when the data is data to be encrypted, the processing circuitry is further configured to,
generate the seed as a random number for encrypting the data, and
incorporate the seed with the encrypted data.

11. The electronic device of claim 10, wherein the processing circuitry is further configured to encrypt the seed before incorporating the seed with the encrypted data.

12. The electronic device of claim 8, wherein when the data is encrypted data to be decrypted, the processing circuitry is further configured to extract the seed from the encrypted data incorporating the seed.

13. The electronic device of claim 8, wherein the processing circuitry is further configured to perform an encryption operation with a data bit of the data as a first input and a key stream bit of the key stream as a second input to generate encrypted data or decrypted data.

14. The electronic device of claim 13, wherein the encryption operation is an XOR encryption.

15. A non-transitory computer readable storage medium having computer readable instructions stored thereon which, when executed by processing circuitry, cause the processing circuitry to perform a method comprising:
generating a sequence of states of a pseudo-random number generator (PRNG), wherein an initial state of the PRNG is generated based on a seed and a key, and each of the other states in the sequence of states of the PRNG is generated based on a previous state of the PRNG and the key;
generating a key stream including a sequence of key sections, wherein each key section is generated by the PRNG based on one of the sequence of the states of the PRNG; and
encrypting or decrypting the data with the key stream to generate encrypted data or decrypted data respectively.

16. The non-transitory computer readable storage medium of claim 15, wherein generating the sequence of states of the PRNG includes,
performing a modulo-m addition or multiplication of the seed and the key to generate the initial state of the PRNG; and
performing a modulo-m addition or multiplication of a previous state of PRNG and the key to generate one of the other states in the sequence of states of the PRNG.

17. The non-transitory computer readable storage medium of claim 15, wherein the data is data to be encrypted, and the method further comprises:
generating the seed as a random number for encrypting the data; and
incorporating the seed with the encrypted data.

18. The non-transitory computer readable storage medium of claim 17, wherein the method further comprises:
encrypting the seed before incorporating the seed with the encrypted data.

19. The non-transitory computer readable storage medium of claim 15, wherein when the data is encrypted data to be decrypted, the method further comprises:
extracting the seed from the encrypted data incorporating the seed.

20. The non-transitory computer readable storage medium of claim 15, wherein encrypting or decrypting the data with the key stream includes,
performing an XOR operation with a data bit of the data as a first input and a key stream bit of the key stream as a second input to generate encrypted data or decrypted data respectively.
